(19) United States
(12) Patent Application Publication
(10) Pub. No.: US 2014/0298392 A1
(43) Pub. Date: Oct. 2, 2014

(54) IMAGE PROCESSING DEVICE, IMAGE PROCESSING METHOD, AND COMPUTER PROGRAM

(71) Applicant: Sony Corporation, Tokyo (JP)

(72) Inventor: Kuniaki Kurihara, Tokyo (JP)

(73) Assignee: Sony Corporation, Tokyo (JP)

(21) Appl. No.: 14/205,920

(22) Filed: Mar. 12, 2014

(30) Foreign Application Priority Data
Mar. 26, 2013 (JP) 2013-064015

(51) Int. Cl. H04N 21/2343; H04N 21/61; H04N 21/238

(52) U.S. Cl. CPC H04N 21/2343; H04N 21/23805; H04N 21/6125
USPC 725/109

(57) ABSTRACT

There is provided an image processing device including a combining unit configured to acquire, for each of a plurality of content items, any of a plurality of streams in which a same content item is encoded by different picture configurations and to combine the acquired streams before the streams are decoded, and a stream selecting unit configured to acquire information on the picture configurations of each of the streams and to select, using the acquired information on the picture configurations, a stream for each of the content items from among the plurality of streams in a manner that the picture configurations of each of the streams combined by the combining unit are same.

### CROSS REFERENCE TO RELATED APPLICATIONS

This application claims the benefit of Japanese Priority Patent Application JP 2013-064015 filed Mar. 26, 2013, the entire contents of which are incorporated herein by reference.

### BACKGROUND

The present disclosure relates to an image processing device, an image processing method, and a computer program.

Since digitization of content and infrastructure that enables transmission of images have been developed, images are more and more commonly distributed through the Internet. In recent years, other than personal computers, more and more television receivers connectable to a network have been made as receiver devices. Thus, it is becoming possible to watch distributed moving image content on television receivers.

Further, cloud service has been developed in recent years, so that a variety of channels including private content have been provided for viewers through a network. Accordingly, there are more and more needs for a multi-image reproducing system that enables simultaneous viewing of a plurality of moving image content items and easy retrieval of a moving image content item to watch.

There is a system that performs multi-screen composite using encoded stream information to achieve simultaneous viewing of a plurality of moving image content items. A plurality of encoded stream information items held by being compressed by a server are converted into one encoded stream information item without a complicated decoding process performed by a client. The multi-screen composite using the encoded stream information can reduce a load on a process performed by the server, a network band to be used, and a load on a process performed by the client.

### SUMMARY

In a technique performing the above-described multi-screen composite using encoded stream information, the assumption is required that configurations of a group of picture (GOP) are the same in all the steams. With existing techniques, there is not a mechanism to change the GOP configurations while keeping the same GOP configurations in all the content items received by the client. In view of the above situation, a technique to change the GOP configurations while keeping the same GOP configurations in all the content items has been demanded.

Accordingly, one or more of embodiments of the present disclosure provides an image processing device, an image processing method, and a computer program which are novel and improved and can change GOP configurations while keeping the same GOP configurations in all content items when performing multi-screen composite using encoded stream information.

According to an embodiment of the present disclosure, there is provided an image processing device including a combining unit configured to acquire, for each of a plurality of content items, any of a plurality of streams in which a same content item is encoded by different conditions and to combine the acquired streams before the streams are decoded, and a stream selecting unit configured to acquire information on the picture configurations of each of the streams and to select, using the acquired information on the picture configurations, a stream for each of the content items from among the plurality of streams in a manner that the picture configurations of each of the streams combined by the combining unit are same.

According to another embodiment of the present disclosure, there is provided an image processing method including acquiring, for each of a plurality of content items, any of a plurality of streams in which a same content item is encoded under different conditions and combining the acquired streams before the streams are decoded, and acquiring information on picture configurations of each of the streams and selecting, using the acquired information on the picture configurations, a stream for each of the content items from among the plurality of streams in a manner that the picture configurations of each of the streams combined in the combining step are same.

According to another embodiment of the present disclosure, there is provided a computer program causing a computer to execute acquiring, for each of a plurality of content items, any of a plurality of streams in which a same content item is encoded under different conditions and combining the acquired streams before the streams are decoded, and acquiring information on picture configurations of each of the streams and selecting, using the acquired information on the picture configurations, a stream for each of the content items from among the plurality of streams in a manner that the picture configurations of each of the streams combined in the combining step are same.

As described above, according to one or more of embodiments of the present disclosure, there can be provided an image processing device, an image processing method, and a computer program which are novel and improved and can change GOP configurations while keeping the same GOP configurations in all content items when performing multi-screen composite using encoded stream information.

### BRIEF DESCRIPTION OF THE DRAWINGS

FIG. 1 shows an overall configuration example of an image processing system 1 according to an embodiment of the present disclosure;

FIG. 2 shows a function configuration example of moving image content servers 2 and 3 according to an embodiment of the present disclosure;

FIG. 3 shows a function configuration example of moving image content servers 2 and 3 according to an embodiment of the present disclosure;

FIG. 4 shows a function configuration example of a client terminal 100 according to an embodiment of the present disclosure;

FIG. 5 shows a process of combining a plurality of encoded streams in a stream combining unit 105;

FIG. 6 shows a process of combining a plurality of encoded streams in a stream combining unit 105;

FIG. 7 shows a state of a plurality of encoded streams that have been combined in a stream combining unit 105;

FIG. 8 is a flow chart showing an operation example of a client terminal 100 according to an embodiment of the present disclosure;

FIG. 9A is a flow chart showing an operation example of a client terminal 100 according to an embodiment of the present disclosure;

FIG. 9B is a flow chart showing an operation example of a client terminal 100 according to an embodiment of the present disclosure;

FIG. 10A is a flow chart showing an operation example of a client terminal 100 according to an embodiment of the present disclosure;

FIG. 10B is a flow chart showing an operation example of a client terminal 100 according to an embodiment of the present disclosure;

FIG. 11A shows an example of content information lists that a client terminal 100 acquires from moving image content servers 2 and 3;

FIG. 11B shows a part extracted from a media presentation description (MPD) file;

FIG. 12 shows lists of GOP configurations common to all moving image content items;

FIG. 13 shows a content information list of GOP configurations that do not exist in other content items;

FIG. 14 shows an example of a content acquiring list c11;

FIG. 15 shows an example of a content acquiring list c12;

FIG. 16 shows an example of a content acquiring list c13;

FIG. 17 shows an example of a content acquiring list c14;

FIG. 18 shows a configuration example of a transfer state determining unit 108;

FIG. 19 shows a configuration example of a GOP configuration information deciding unit 109;

FIG. 20 shows an example where requested values in respective priorities correspond to GOP configurations that are common to all moving image content items;

FIG. 21 shows a configuration example of a GOP configuration information deciding unit 109; and

FIG. 22 shows a configuration example of a rate information deciding unit 110.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

<1. Embodiment of Present Disclosure>

Overall Configuration Example]

[Function Configuration Example of Moving Image Content Server]

[Function Configuration Example of Client Terminal]

[Operation Example of Client Terminal]

<2. Conclusion>

### 1. EMBODIMENT OF PRESENT DISCLOSURE

### Overall Configuration Example

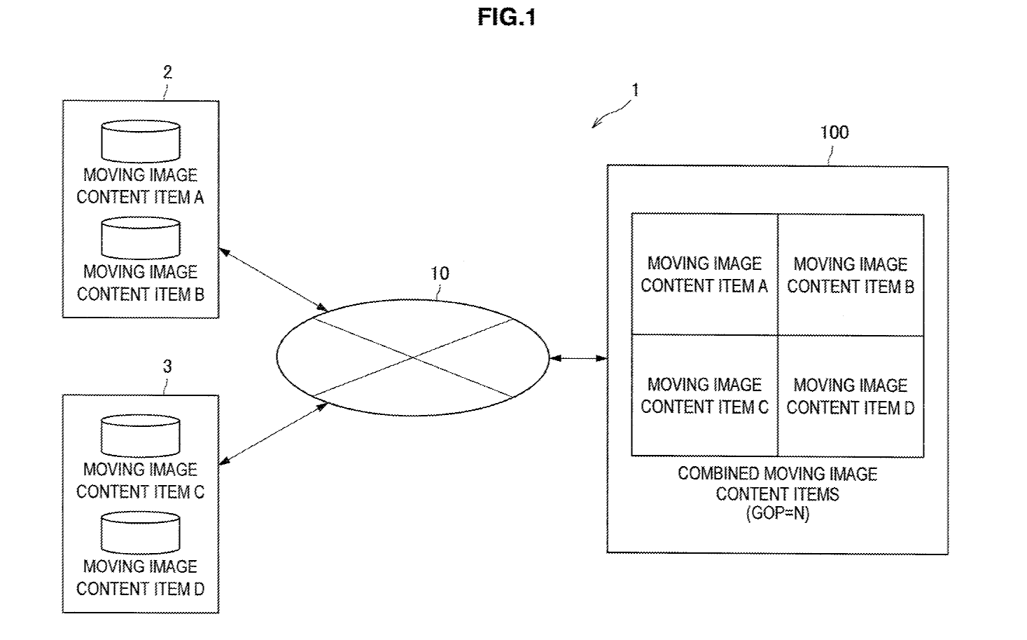

First of all, an overall configuration example of a system according to an embodiment of the present disclosure will be described with reference to drawings. FIG. 1 shows an overall configuration example of an image processing system 1 according to an embodiment of the present disclosure. The overall configuration example of the image processing system 1 according to an embodiment of the present disclosure will be described below with reference to FIG. 1.

The image processing system 1 shown in FIG. 1 has a configuration in which a client terminal 100 receives encoded stream information from a plurality of moving image content servers 2 and 3 through a network 10 such as the Internet, and the client terminal 100 combines a plurality of moving image content items and reproduces the combined moving image content items simultaneously.

The moving image content servers 2 and 3 each hold moving image content that is converted into encoded streams, convert moving image content into encoded streams, and transmit the encoded streams to the client terminal 100 in accordance with a request from the client terminal 100. In this embodiment, the moving image content server 2 holds a moving image content item A and a moving image content item B. The moving image content items A and B may each be a moving image content item that is shot in real time or a moving image content item that has been shot in advance. Further, the moving image content server 3 holds a moving image content item C and a moving image content item D. The moving image content items C and D may each be a moving image content item that is shot in real time or a moving image content item that has been shot in advance. It is needless to say that kinds and the number of moving image content items held by the moving image content servers are not limited to the above examples.

The encoded streams in this embodiment are encoded by an H.264/advanced video coding (AVC) scheme, for example.

The client terminal 100 receives a plurality of the encoded streams that are transmitted from the moving image content servers 2 and 3 through the network 10 such as the Internet, combines the plurality of the encoded streams, and decodes the combined encoded streams. By decoding the plurality of encoded streams after composite, the client terminal 100 can reproduce a plurality of moving image content items simultaneously. Note that the simultaneous reproduction of a plurality of moving image content items may be executed by the client terminal 100 or may be executed by another device having a display screen and connected to the client terminal 100 with or without wires.

Each of the moving image content items that are received, combined, and reproduced by the client terminal 100 is assumed to have N groups of pictures (GOP). The same GOP in the moving image content items enables the client terminal 100 to combine the plurality of encoded streams and to decode the combined encoded streams.

At the same time, however, the client terminal 100 may fail to combine moving image content items having different GOP configurations, i.e., different numbers of pictures (picture configurations) that form a set of pictures including at least one I picture.

In AVC encoded stream information used in the existing techniques, the GOP configuration of content can be arbitrary decided. Further, in many cases, the GOP configuration is decided in advance by the server providing the content. Reference techniques that can be used to select the GOP configuration in such an environment include an HTTP adaptive streaming scheme and an MPEG-DASH (ISO/IEC 23009-1). These techniques enable selection of content acquired from the server in accordance with the resolution (size) of content necessary for the client and a usable bandwidth of a network.

It is technically easy to add a configuration to select the GOP configuration in the same manner as the selection of the resolution and the rate of content, using these techniques. However, the existing techniques do not have any mechanism to select content having the same GOP configuration, which is a condition for performing multi-screen composite in which a plurality of encoded streams are combined and then the combined encoded streams are decoded.

In some cases, by changing the GOP configuration of moving image content received from the server, the client can reproduce the moving image content in the most suitable state. However, when performing the multi-screen composite in which the plurality of encoded streams are combined and then the combined encoded streams are decoded, it is not easy to change the GOP configuration of moving image content.

In the AVC encoded stream information, when considering the compressibility of content, the time to restoration of reproduction in a decoder at a packet loss, the switching speed of moving image content, and the like, there are GOP configurations that are the most suitable for the respective situations.

For example, when the GOP configuration of moving image content is shortened, intervals of IDP pictures are shortened. When the intervals of IDP pictures are shortened, the band of a network consumed by the moving image content is increased. Meanwhile, in a case where the GOP configuration of moving image content is shortened, while the client is reproducing the moving image content when the moving image content is switched to other moving image content, the switching time can be shortened because the intervals of IDP pictures are short.

Further, in an environment in which a packet loss affects the decoder, such as a case where UDP is used as network transmission, by shortening the GOP configuration, it becomes possible to restart reproducing the image in a short time after the occurrence of the packet loss.

In contrast, when the GOP configuration of moving image content is lengthened, the intervals of IDR pictures are lengthened. When the intervals of IDR pictures are lengthened, the efficiency of encoding moving image content is increased. Accordingly, when the usable band is the same, the client can reproduce moving image content having a longer GOP configuration in a preferable manner.

The image processing system 1 according to an embodiment of the present disclosure can change a GOP configuration while keeping the same GOP configuration (picture configuration) in all content items when performing multi-screen composite using encoded stream information.

The overall configuration example of the image processing system 1 according to an embodiment of the present disclosure has been described above with reference to FIG. 1. Next, function configuration examples of the moving image content servers 2 and 3 according to an embodiment of the present disclosure will be described.

### [Function Configuration Example of Moving Image Content Server]

As described above, the moving image content servers 2 and 3 according to an embodiment of the present disclosure can each hold any of real-time moving image content and accumulated moving image content. Accordingly, function configuration examples of the moving image content servers 2 and 3 according to an embodiment of the present disclosure in a case where the real-time moving image content is distributed and in a case where the accumulated moving image content is distributed will be described.

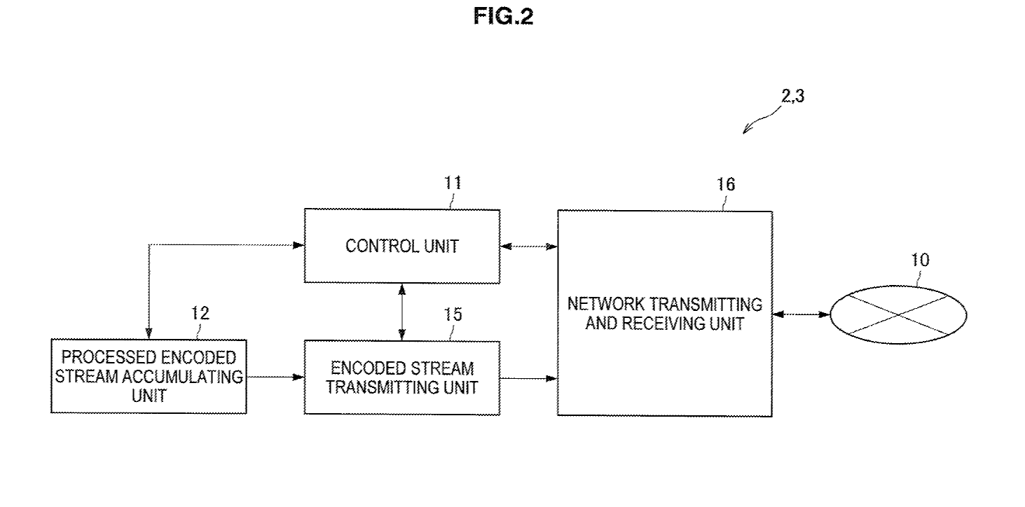

FIG. 2 shows a function configuration example of the moving image content servers 2 and 3 according to an embodiment of the present disclosure. FIG. 2 shows the function configuration example of the moving image content servers 2 and 3 when the real-time moving image content is distributed.

As shown in FIG. 2, the moving image content servers 2 and 3 according to an embodiment of the present disclosure each include a control unit 11, a processed encoded stream accumulating unit 12, an encoded stream transmitting unit 15, and a network transmitting and receiving unit 16.

The control unit 11 controls operation of each element in the moving image content servers 2 and 3. The processed encoded stream accumulating unit 12 recodes moving image content in advance and accumulates recoded encoded streams. The recoded encoded streams of moving image content, which are accumulated in the processed encoded stream accumulating unit 12, are transmitted to the encoded stream transmitting unit 15 under control of the control unit 11.

Encoded streams using the H.264/AVC scheme has a dependence relationship with context-based adaptive binary arithmetic coding (CABAC), intra macro block (MB) prediction, motion vector prediction, and the like, in the same slice. Coding is performed in every horizontal line from the top, and from the left in each horizontal line.

The processed encoded stream accumulating unit 12 accumulates macro blocks of the encoded streams of moving image content, the macro blocks being arranged in the horizontal direction and recoded as the same slice. By recoding the macro blocks arranged in the horizontal direction as the same slice, the dependence relationship between macro blocks having different positions in the vertical direction disappears in each moving image content item. Therefore, by combining a plurality of encoded streams of moving image content items in the client terminal 100, even when the encoding order of the macro blocks is different, the multi-picture reproduction image that is subjected to decoding becomes the same as the image of the original moving image content.

The encoded stream transmitting unit 15 causes the network transmitting and receiving unit 16 to transmit the encoded streams of moving image content accumulated in the processed encoded stream accumulating unit 12 using a protocol such as a transmission control protocol (TCP) or a real-time transport protocol (RTP), under control of the control unit 11.

The network transmitting and receiving unit 16 receives data from the network 10 and transmits data to the network 10. In this embodiment, the network transmitting and receiving unit 16 receives the encoded streams of moving image content transmitted from the encoded stream transmitting unit 15 and transmits the encoded streams to the network 10 under control of the control unit 11.

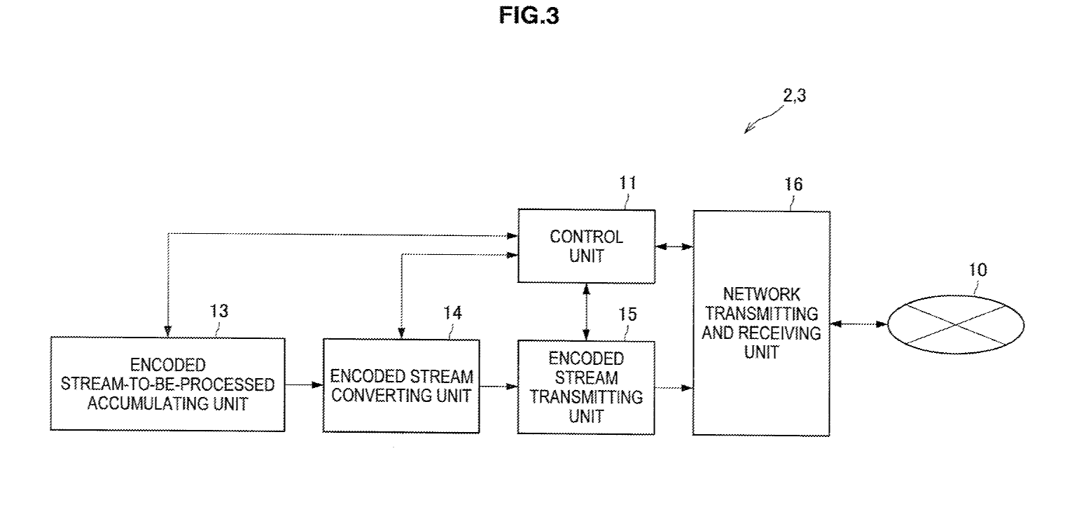

FIG. 3 shows a function configuration example of the moving image content servers 2 and 3 according to an embodiment of the present disclosure. FIG. 3 shows the function configuration example of the moving image content servers 2 and 3 when the accumulated moving image content is distributed, for example.

As shown in FIG. 3, the moving image content servers 2 and 3 according to an embodiment of the present disclosure each include the control unit 11, an encoded stream-to-be-processed accumulating unit 13, an encoded stream converting unit 14, the encoded stream transmitting unit 15, and the network transmitting and receiving unit 16.

The control unit 11 controls operation of each element in the moving image content servers 2 and 3. The encoded stream-to-be-processed accumulating unit 13 accumulates encoded streams of moving image content that is not subjected to the above-described recoding. The encoded streams of moving image content accumulated in the encoded stream-to-be-processed accumulating unit 13 are transmitted to the encoded stream converting unit 14 under control of the control unit 11.

The encoded stream converting unit 14 performs the above-described recoding on the encoded streams of moving image content under control of the control unit 11. After recoding the encoded streams of moving image content, the encoded stream converting unit 14 transmits the recoded encoded streams of moving image content to the encoded stream transmitting unit 15 under control of the control unit 11.

The encoded stream transmitting unit 15 causes the network transmitting and receiving unit 16 to transmit the encoded streams of moving image content transmitted from the encoded stream converting unit 14 using a protocol such as a TCP or an RTP, under control of the control unit 11. The network transmitting and receiving unit 16 receives data from the network 10 and transmits data to the network 10. In this embodiment, the network transmitting and receiving unit 16 receives the encoded streams of moving image content transmitted from the encoded stream transmitting unit 15 and transmits the received encoded streams to the network 10 under control of the control unit 11.

With the configuration shown in FIG. 2 or FIG. 3, the moving image content servers 2 and 3 according to an embodiment of the present disclosure can transmit encoded streams suitable for composite of a plurality of encoded streams in the client terminal 100 to the client terminal 100.

The moving image content servers 2 and 3 according to an embodiment of the present disclosure can hold files that are encoded under different conditions with respect to the same moving image content. That is, the moving image content servers 2 and 3 according to an embodiment of the present disclosure can hold files having different resolutions, encoding rates, and GOP configurations with respect to the same moving image content. Further, the moving image content servers 2 and 3 according to an embodiment of the present disclosure selects one file from among the files encoded under different conditions in accordance with conditions requested from the client terminal 100 or the state of the network 10, and streaming distribute the file to the client terminal 100.

The function configuration examples of the moving image content servers 2 and 3 according to an embodiment of the present disclosure have been described above with reference to FIGS. 2 and 3. Next, a function configuration example of the client terminal 100 according to an embodiment of the present disclosure will be described.

### [Function Configuration Example of Client Terminal]

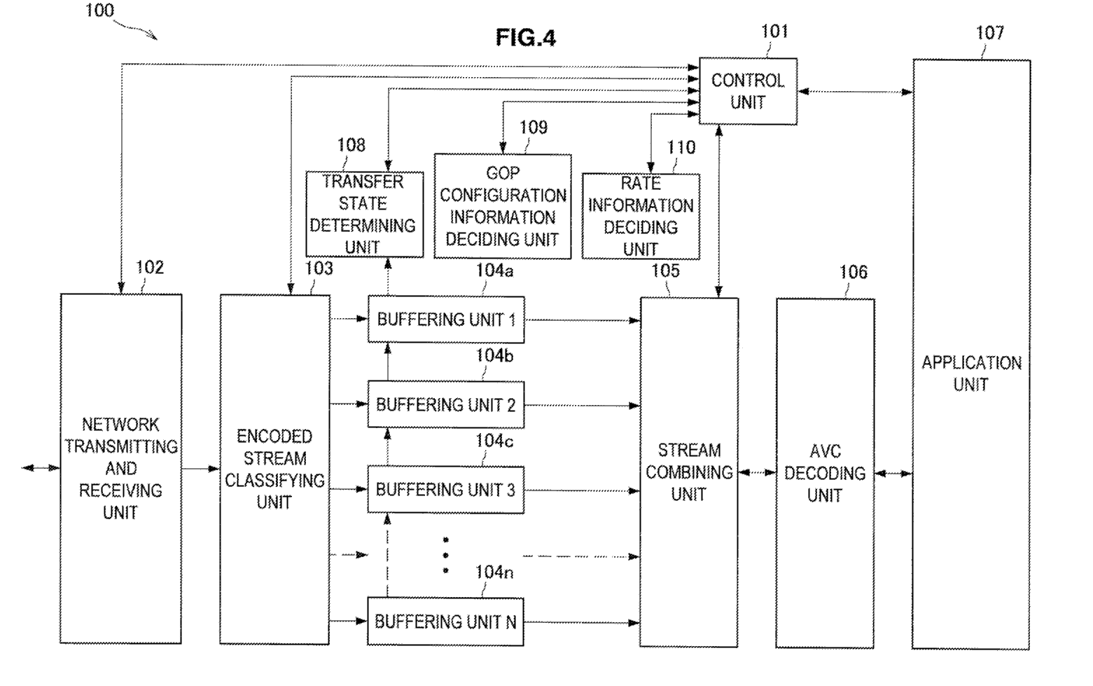

FIG. 4 shows a function configuration example of the client terminal 100 according to an embodiment of the present disclosure. FIG. 4 shows an example of the client terminal 100 having a configuration for simply combining and reproducing encoded streams transmitted from the moving image content servers 2 and 3. The function configuration example of the client terminal 100 according to an embodiment of the present disclosure will be described below with reference to FIG. 4.

As shown in FIG. 4, the client terminal 100 according to an embodiment of the present disclosure includes a control unit 101, a network transmitting and receiving unit 102, an encoded stream classifying unit 103, content buffering units 104a, 104b, 104c, . . . , 104n, a stream combining unit 105, an AVC decoding unit 106, an application unit 107, a transfer state determining unit 108, a GOP configuration information deciding unit 109, and a rate information deciding unit 110.

The control unit 101 controls operation of each element in the client terminal 100. The network transmitting and receiving unit 102 receives data from the network 10 and transmits data to the network 10 under control of the control unit 101. In this embodiment, the network transmitting and receiving unit 102 receives the encoded streams transmitted from the moving image content servers 2 and 3. The network transmitting and receiving unit 102 outputs the received encoded streams to the encoded stream classifying unit 103 in accordance with control of the control unit 101. Since the network transmitting and receiving unit 102 can receive a plurality of encoded streams simultaneously, when a plurality of encoded streams are received, the plurality of encoded streams are classified by the encoded stream classifying unit 103 in a latter stage.

The encoded stream classifying unit 103 classifies the encoded streams that the network transmitting and receiving unit 102 has received, in moving image content unit. As described above, since the network transmitting and receiving unit 102 can receive a plurality of encoded streams simultaneously, when a plurality of encoded streams are received, the encoded stream classifying unit 103 classifies the plurality of encoded streams in moving image content unit. The encoded stream classifying unit 103 can classify the encoded streams in moving image content unit by referring to information for identifying content contained in the received encoded streams, for example. After classifying the encoded streams in moving image content unit, the encoded stream classifying unit 103 outputs the classified encoded streams to the content buffering units 104a, 104b, 104c, . . . , 104n in moving image content unit.

The content buffering units 104a, 104b, 104c, . . . , 104n each hold, in moving image content unit, the encoded streams classified by the encoded stream classifying unit 103 in moving image content unit. The encoded streams held in the respective content buffering units 104a, 104b, 104c, . . . , 104n in moving image content unit are output to the stream combining unit 105.

The stream combining unit 105 extracts and combines the encoded streams held in moving image content unit in each of the content buffering units 104a, 104b, 104c, . . . , 104n under control of the control unit 101. The stream combining unit 105 rewrites slice headers of encoded streams of a plurality of moving image content items to combine the plurality of encoded streams as one. After combining the plurality of encoded streams as one, the stream combining unit 105 outputs the combined encoded stream to the AVC decoding unit 106.

An example of a composite process in the stream combining unit 105 will be described. The stream combining unit 105 recognizes, from encoded streams of a plurality of moving image content items, a data length I of a network abstraction layer (NAL) unit of a slice and a number sx of macro blocks of a slice. Then, based on the data length I, the number sx of macro blocks, and arrangement of the plurality of moving image content items in a reproduction image, the stream combining unit 105 rewrites the slice headers of encoded streams of the plurality of moving image content items.

Further, the stream combining unit 105 acquires, from the NAL unit of a picture parameter set (PPS) included in each encoded stream of the plurality of moving image content items supplied from the content buffering units 104a, 104b, 104c, . . . , 104n, a reversible encoding system flag representing a reversible encoding system. Here, examples of the reversible encoding system include context-adaptive variable length coding (CAVLC) and context-adaptive binary arithmetic coding (CABAC). Further, the reversible encoding system flag is 1 when representing CABAC and is 0 when representing CAVLC.

Based on the reversible encoding system flag, the stream combining unit 105 performs a predetermined process on slice data of each encoded stream of the plurality of moving image content items whose slice headers are rewritten. Further, based on arrangement of the plurality of moving image content items in the reproduction image, the stream combining unit 105 combines the encoded streams of moving image content items including the slice data that has been subjected to the above-described predetermined process and the rewritten slice header, thereby generating encoded streams of the reproduction image for reproducing the plurality of moving image content items as one image.

The AVC decoding unit 106 decodes the encoded streams that have been combined as one by the stream combining unit 105 under control of the control unit 101. By decoding the encoded streams that have been combined as one by the stream combining unit 105, the AVC decoding unit 106 can generate and output the reproduction image for reproducing the plurality of moving image content items as one image. The AVC decoding unit 106 outputs the decoded data to the application unit 107.

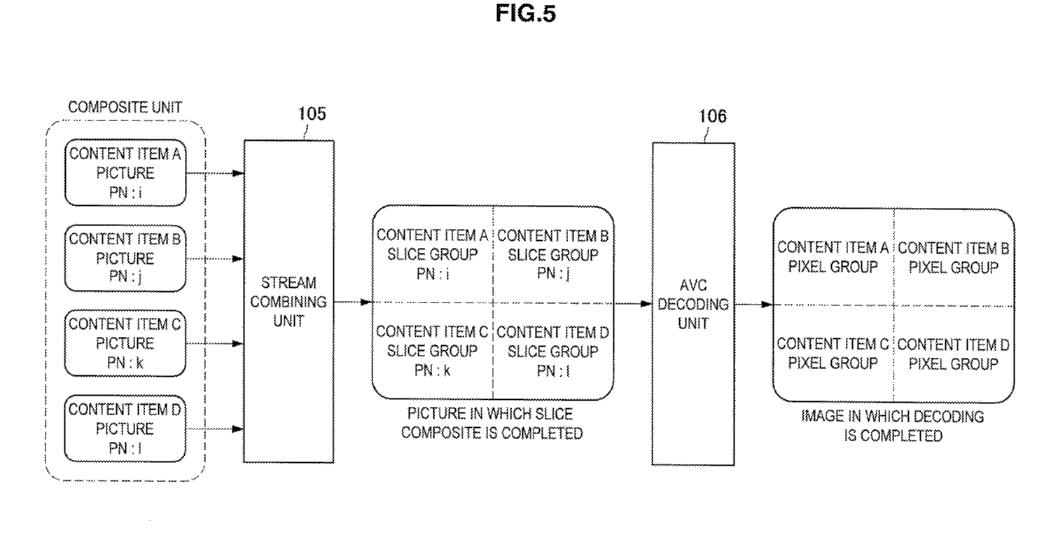

Here, a process of combining the plurality of encoded streams in the stream combining unit 105 will be specifically described. FIG. 5 shows the process of combining the plurality of encoded streams in the stream combining unit 105. FIG. 5 shows the process of combining encoded streams of four moving image content items: moving image content items A to D. FIG. 5 shows an example in which the stream combining unit 105 combines a picture whose picture number PN of the moving image content item A is i, a picture whose picture number PN of the moving image content item B is j, a picture whose picture number PN of the moving image content item C is k, and a picture whose picture number PN of the moving image content item D is 1.

Encoded streams of the four moving image content items A to D are combined by the stream combining unit 105, and then the encoded streams are output from the stream combining unit 105 as one picture in which slice composite is completed. The encoded streams that have become one picture are decoded by the AVC decoding unit 106 to be output from the AVC decoding unit 106 as pixel groups of the respective moving image content items A to D.

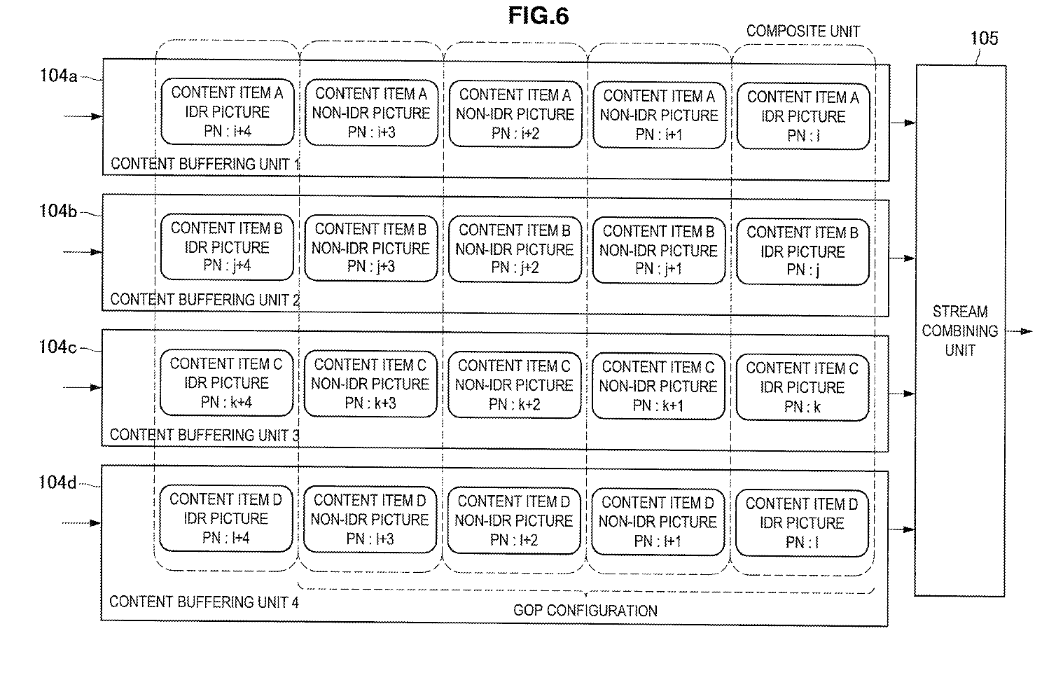

FIG. 6 shows a process of combining a plurality of encoded streams in the stream combining unit 105. FIG. 6 also shows the content buffering units 104a, 104b, 104c, and 104d. When combining the plurality of encoded streams, the stream combining unit 105 arranges GOP configurations of all the encoded streams. That is, as shown in FIG. 6, composite is performed such that pictures in composite unit are the same kinds of pictures (IDR pictures or non-IDR pictures).

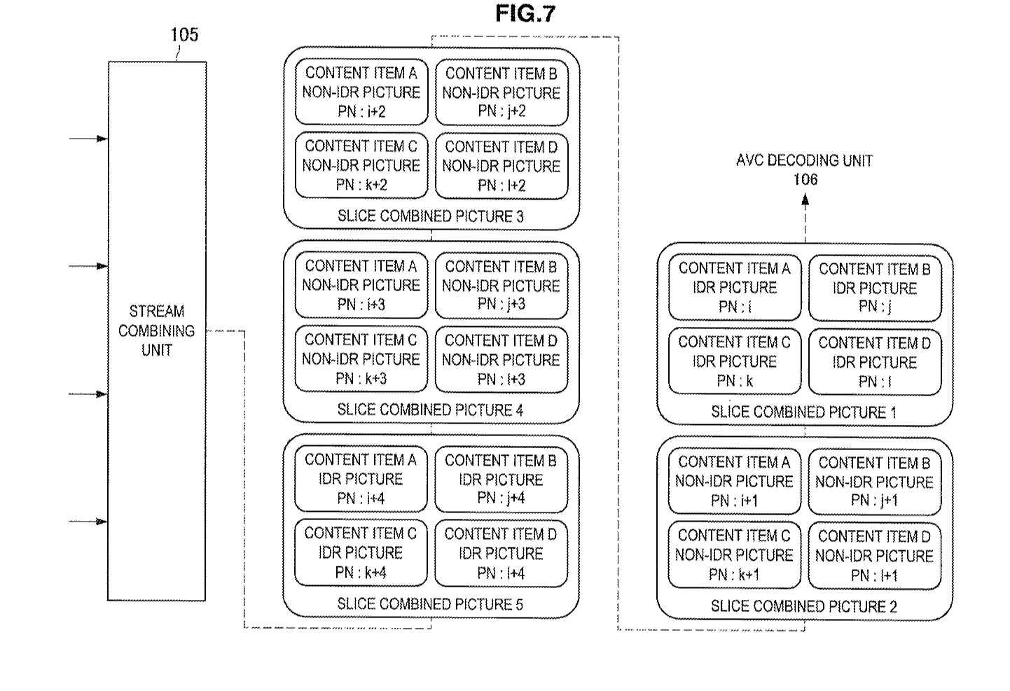

FIG. 7 shows the state of the plurality of encoded streams that are combined in the stream combining unit 105. After the encoded streams of the four moving image content items A to D are combined (slice combined) in picture unit in the stream combining unit 105, as shown in FIG. 7, the combined encoded streams are output from the stream combining unit 105 in picture unit and transmitted to the AVC decoding unit 106.

By arranging the kinds of pictures and decoding the combined encoded streams that are transmitted from the stream combining unit 105 in this manner, the AVC decoding unit 106 can generate an image having pixel groups of the respective moving image content items A to D.

The application unit 107 executes application that is executed by the client terminal 100. The application unit 107 acquires data output from the AVC decoding unit 106. The application unit 107 then can display an image, obtained by decoding, on a display screen, or transfer the image to another device having a display screen, under control of the control unit 101.

The transfer state determining unit 108 determines the transfer state of the moving image content items from the moving image content servers 2 and 3 to the client terminal 100. The transfer state determining unit 108 functions as an example of a situation detecting unit according to an embodiment of the present disclosure. Specifically, the transfer state determining unit 108 determines the transfer state by measuring a packet loss rate or a flow-in rate to the content buffering units 104a, 104b, 104c, . . . , 104n. After determining the transfer state of the moving image content items from the moving image content servers 2 and 3 to the client terminal 100, the transfer state determining unit 108 transmits the determination results to the control unit 101. A detailed configuration of the transfer state determining unit 108 will be described later.

The GOP configuration information deciding unit 109 decides the GOP configuration such that the GOP configuration becomes the same in all moving image content items that are distributed from the moving image content servers 2 and 3 and to be combined by the stream combining unit 105. The GOP configuration information deciding unit 109 functions as an example of a steam selecting unit according to an embodiment of the present disclosure. Based on setting set by a user of the client terminal 100 or the transfer state determined by the transfer state determining unit 108, for example, the GOP configuration information deciding unit 109 can decide the GOP configuration such that the GOP configuration becomes the same in all the moving image content items. Further, the GOP configuration information deciding unit 109 can decide the GOP configuration using information on the GOP configuration prepared by a distribution rate of moving image content decided by the rate information deciding unit 110 which will be described later. The GOP configuration information deciding unit 109 transmits the decided information on the GOP configuration to the control unit 101. A detailed configuration of the GOP configuration information deciding unit 109 will be described later.

The rate information deciding unit 110 decides distribution rates of moving image content items distributed from the moving image content servers 2 and 3. The rate information deciding unit 110 decides the distribution rates of moving image content items distributed from the moving image content servers 2 and 3 based on setting set by a user of the client terminal 100 or the transfer state determined by the transfer state determining unit 108, for example. The rate information deciding unit 110 transmits information on the decided distribution rates of moving image content items to the control unit 101. A detailed configuration of the rate information deciding unit 110 will be described later.

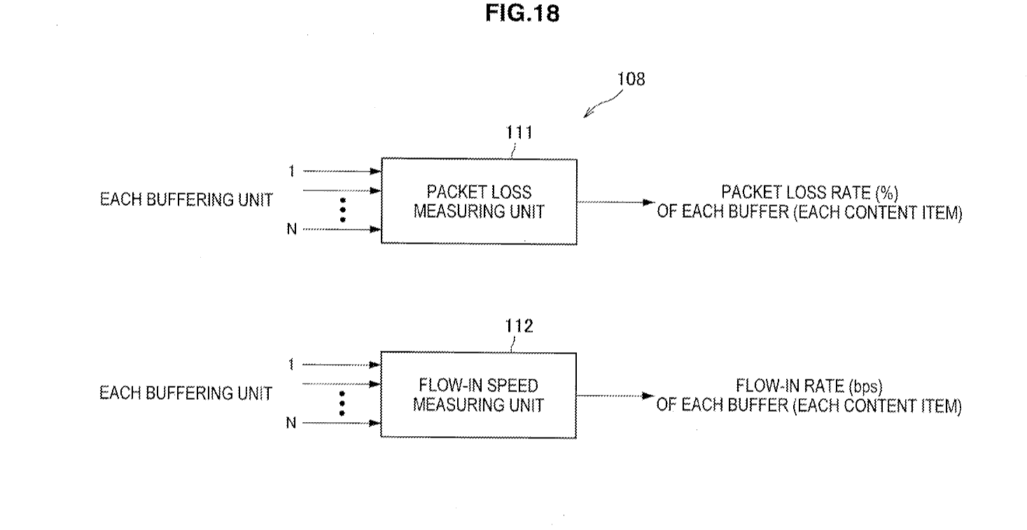

FIG. 18 shows a configuration example of the transfer state determining unit 108. As shown in FIG. 18, the transfer state determining unit 108 includes a packet loss measuring unit 111 and a flow-in speed measuring unit 112.

The packet loss measuring unit 111 calculates packet loss rates of data flowing into the content buffering units 104a, 104b, 104c, . . . , 104n, and outputs information on the packet loss rate of each buffer in percentage. The flow-in speed measuring unit 112 calculates flow-in rates of data flowing into the content buffering units 104a, 104b, 104c, . . . , 104n, and outputs information on the flow-in rate to each buffer in a unit of bps.

With the configuration shown in FIG. 4, the client terminal 100 according to an embodiment of the present disclosure can change a GOP configuration while keeping the same GOP configuration in all content items when performing multi-screen composite using encoded stream information.

The function configuration example of the client terminal 100 according to an embodiment of the present disclosure has been described above. Next, an operation example of the client terminal 100 according to an embodiment of the present disclosure will be described.

### [Operation Example of Client Terminal]

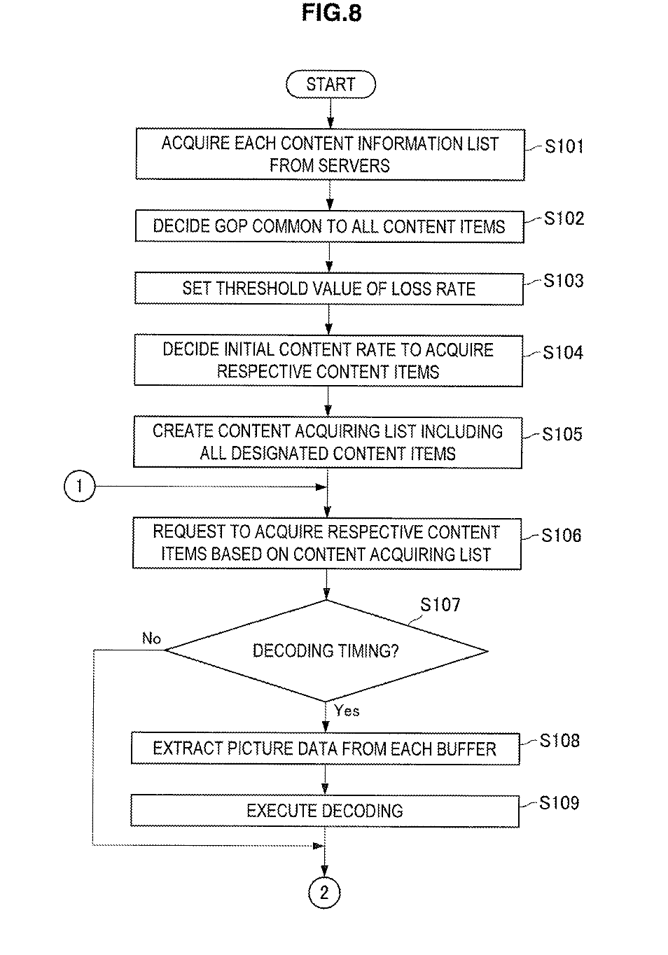

FIGS. 8 to 10B are each a flow chart showing the operation example of the client terminal 100 according to an embodiment of the present disclosure. FIGS. 8 to 10B show processes in which the client terminal 100 receives a plurality of encoded streams from the moving image content servers 2 and 3, combines a picture, and encodes the combined picture, thereby reproducing a plurality of moving image content items simultaneously. Further, FIGS. 8 to 10B show processes in which GOP configurations are changed when the plurality of moving image content items are simultaneously reproduced. The operation example of the client terminal 100 according to an embodiment of the present disclosure will be described below with reference to FIGS. 8 to 10B.

When receiving the plurality of encoded streams from the moving image content servers 2 and 3, the client terminal 100 acquires information of content items held by the moving image content servers 2 and 3 as content information lists (step S101).

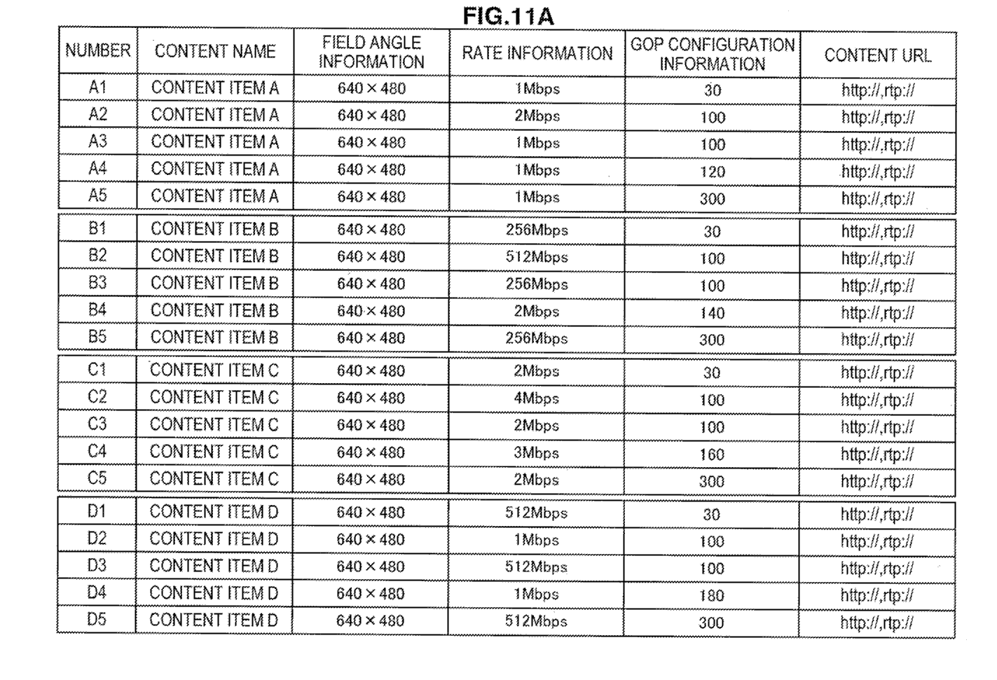

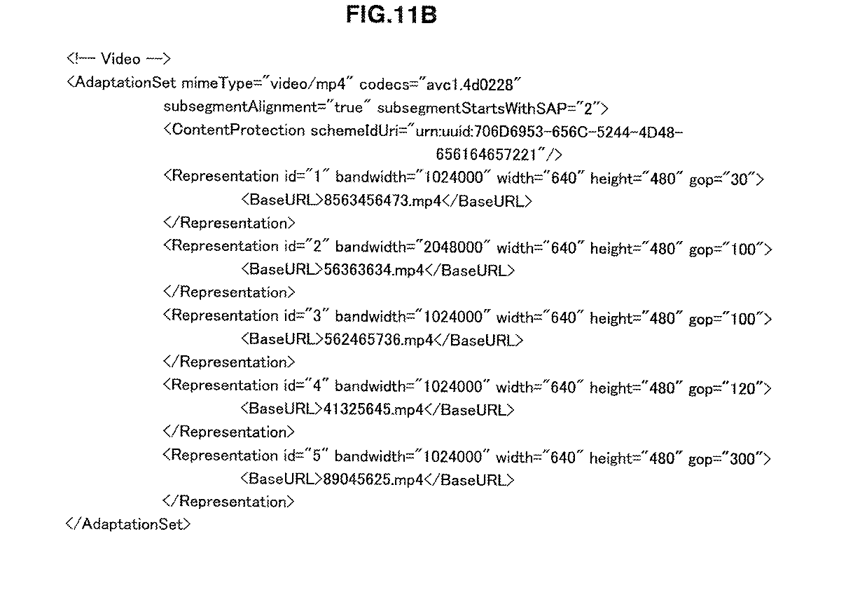

FIG. 11A shows an example of the content information lists that the client terminal 100 acquires from the moving image content servers 2 and 3. FIG. 11A shows an example of the content information lists in which resolution information, rate information, GOP configuration information, and a content URL are described for each of the four content items A, B, C, and D.

Taking the content item A as an example, the content information list shows that files are prepared which have a resolution of 640 in width×480 in height, a rate of either 1 Mbps or 2 Mbps, and a GOP configuration of any of 30, 100, 120, and 300.

The content information list shown in FIG. 11A can also show the same subjects technically by using the HTTP adaptive streaming scheme, the MPEG-DASH (ISO/IEC 23009-1), and the like.

FIG. 11B shows a part extracted from a media presentation description (MPD) file that manages subjects of distributed content items when MPEG-DASH (ISO/IEC 23009-1) is used. FIG. 11B shows a part, extracted from the MPD file, where a compression scheme of a moving image, an image size, an encoding rate, a GOP configuration, and a place where a file is stored are described.

The moving image content servers 2 and 3 each hold in advance the MPD file in which the description is made as shown in FIG. 11B. When the client terminal 100 requests distribution of moving image content items, the moving image content servers 2 and 3 provide the client terminal 100 with the MPD files in which the description is made as shown in FIG. 11B. The client terminal 100 acquires the MPD files in which the description is made as shown in FIG. 11B from the moving image content servers 2 and 3, thereby acquiring information on the compression scheme of a moving image, the image size, the encoding rate, the GOP configuration, and the place where a file is stored, of the distributed moving image content items. Then, the client terminal 100 acquires the MPD files, and the GOP configuration information deciding unit 109 can decide the same GOP configurations in all the moving image content items that are to be combined by the stream combining unit 105.

Although in this embodiment, the moving image content servers 2 and 3 hold moving image content items having predetermined GOP configurations, the present disclosure is not limited to this example. For example, when GOP configurations are only 50 or 200 and the client terminal 100 requests a moving image content item having a GOP configuration of 100, the moving image content servers 2 and 3 may convert the GOP configurations of prepared moving image content and dynamically generate the moving image content item having a GOP configuration of 100. The moving image content servers 2 and 3 may provide the client terminal 100 with the GOP configuration information in which a range of GOP configurations that can be provided is described.

After acquiring the content information held by the moving image content servers 2 and 3 as the content information lists in step S101, the client terminal 100 refers to the acquired content information lists and decides GOP configurations common to all the moving image content items (step S102).

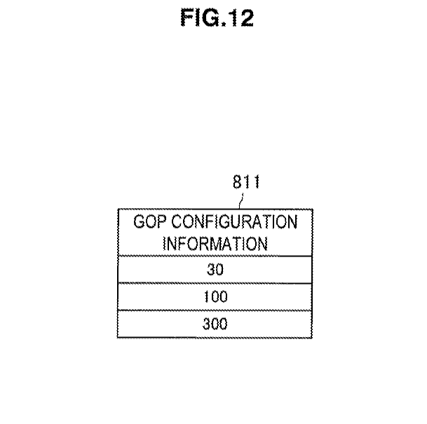

For example, when acquiring the content information lists shown in FIG. 11A from the moving image content servers 2 and 3, the client terminal 100 can acquire the information that three GOP configurations, which are 30, 100, and 300, are common to the content items A to D, with the GOP configuration information deciding unit 109, for example. FIG. 12 shows lists of GOP configurations common to the moving image content items A to D when the content information lists shown in FIG. 11A are acquired. The GOP configuration information deciding unit 109 can generate a GOP configuration information list 811 shown in FIG. 12 showing the GOP configurations common to all the content items, from the content information lists.

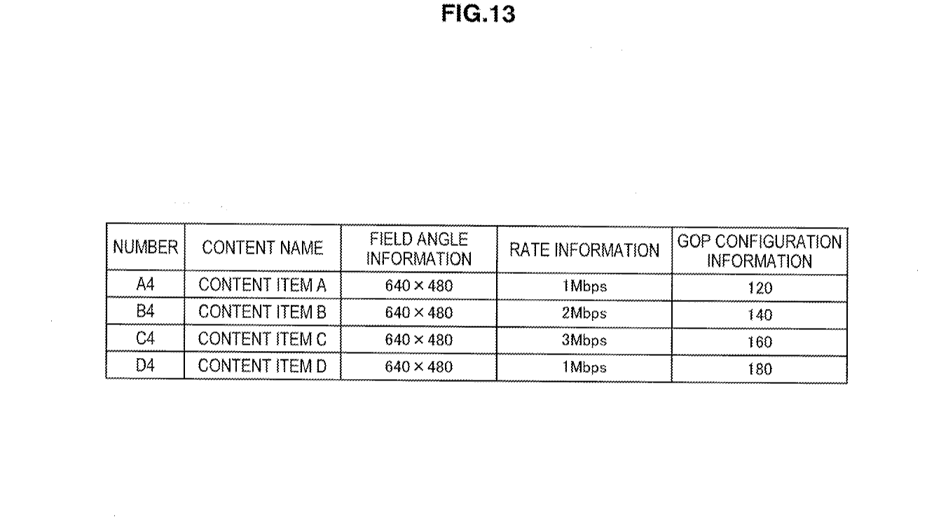

The client terminal 100 may remove information on GOP configurations that do not exist in the other content items from the content information lists. FIG. 13 shows a content information list of GOP configurations that do not exist in the other content items. Since none of the GOP configurations shown in FIG. 13 exists in the other content items, the GOP configurations are difficult to use in a subsequent process of changing GOP configurations. Therefore, the client terminal 100 may remove the information shown in FIG. 13 from the content information lists.

After deciding the GOP configurations common to all the moving image content items in step S102, the client terminal 100 selects one of the common GOP configurations as an initial GOP configuration in accordance with a preference of a user or a direction of the application.

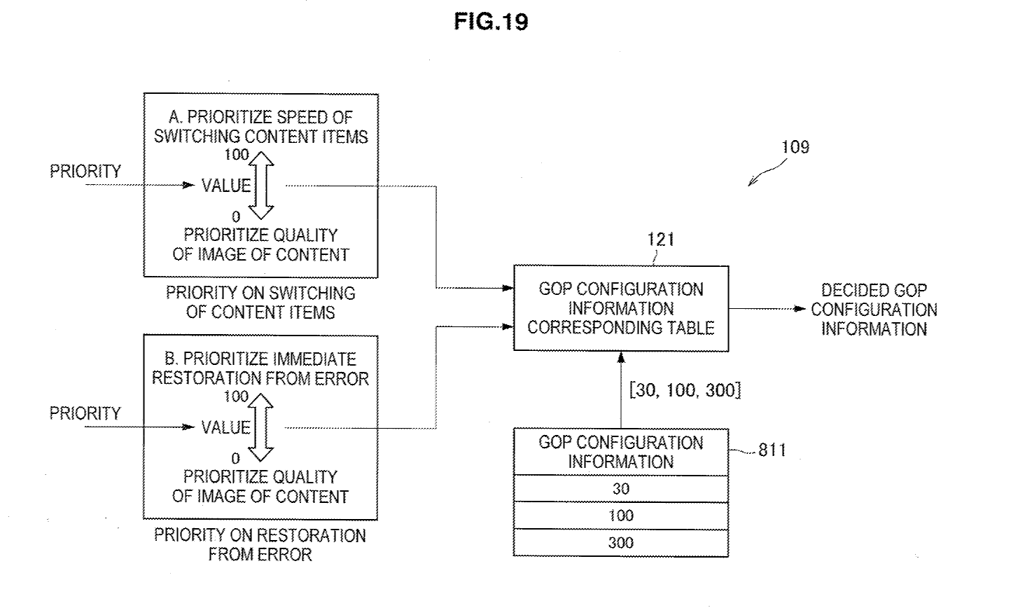

FIG. 19 shows a configuration example of the GOP configuration information deciding unit 109. The GOP configuration information deciding unit 109 shown in FIG. 19 has a mechanism to select one GOP configuration from among the GOP configurations common to all the moving image content items, using a simple index, in order to have a priority on the speed of switching content items or on immediate restoration from an error state such as a packet loss.

The GOP configuration information deciding unit 109 shown in FIG. 19 includes a GOP configuration information corresponding table 121. The GOP configuration information corresponding table 121 stores the GOP configuration information list 811 shown in FIG. 12 showing the GOP configurations common to all the content items. The GOP configuration information corresponding table 121 stores the GOP configuration information list 811 in association with a requested value on each priority shown in FIG. 19.

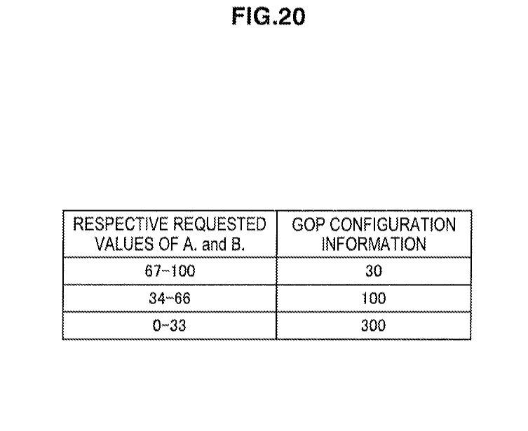

FIG. 20 shows an example where the requested values on the respective priorities shown in FIG. 19 correspond to the GOP configurations common to all the moving image content items. The example shown in FIG. 20 shows that mapping is made such that the GOP configuration is 300 when the requested value is between 0 and 33, the GOP configuration is 100 when the requested value is between 34 and 66, and the GOP configuration is 30 when the requested value is between 67 to 100. It is needless to say that the correspondence relationship between the requested values on the respective priorities and the GOP configurations common to all the moving image content items is not limited to this example.

For example, when the user of the client terminal 100 designates 100 as the priority for switching content items in order to switch the content items immediately, the GOP configuration information deciding unit 109 can decide 30 as the GOP configuration because of the designation of 100 as the priority. Further, when using the other standard of the priority on immediate restoration from an error, the GOP configuration information deciding unit 109 can also decide the GOP configuration in a similar manner.

The priority on switching content items may be designated by the application executed by the application unit 107. Further, the priority on switching content items may decrease over time.

The priority on restoration from an error may be designated by the application executed by the application unit 107. Further, the priority on restoration from an error may be decided based on the respective packet loss rates of the content buffering units 104a, 104b, 104c, . . . , 104n.

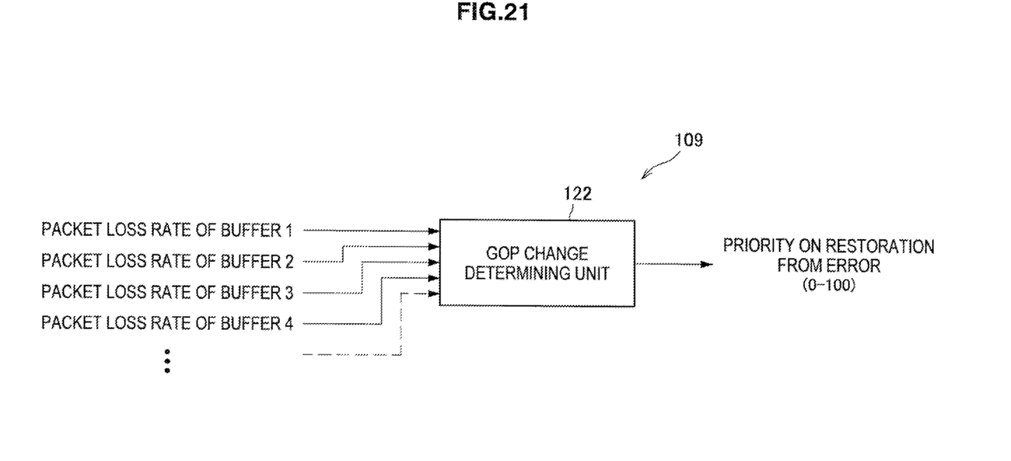

FIG. 21 shows a configuration example of the GOP configuration information deciding unit 109. FIG. 21 shows a configuration example of the GOP configuration information deciding unit 109 for outputting the priority on restoration from an error based on the respective packet loss rates of the content buffering units 104a, 104b, 104c, . . . , 104n, measured by the transfer state determining unit 108.

As shown in FIG. 21, the GOP configuration information deciding unit 109 includes a GOP change determining unit 122. The GOP change determining unit 122 receives the respective packet loss rates of the content buffering units 104a, 104b, 104c, . . . , 104n, measured by the transfer state determining unit 108, and decides a value between 0 and 100 as the priority on restoration from an error based on the received packet loss rates.

For example, the GOP change determining unit 122 receives the respective packet loss rates of the content buffering units 104a, 104b, 104c, . . . , 104n, and further receives an average bit rate or one HTTP live streaming (HLS) segment to decide a value between 0 and 100 as the priority on restoration from an error.

After deciding the initial GOP configuration, the client terminal 100 executes initial setting for changing GOP configurations. In the example shown in FIG. 8, the client terminal 100 sets a threshold value of the packet loss rate as an index for changing GOP configurations (step S103). The threshold value of the packet loss rate is a threshold value for increasing or decreasing a GOP configuration. The client terminal 100 may designate two threshold values of the packet loss rates. By designating the two threshold values of the packet loss rates, the client terminal 100 can have a hysteresis on an operation to increase or decrease the GOP configuration.

After setting the threshold value(s) of the packet loss rate(s) as an index for changing GOP configurations, the client terminal 100 decides a content rate at an initial stage when acquiring the respective moving image content items (step S104). The rate information deciding unit 110 can decide the content rate in step S104. At a stage where a usable network band is unknown, as in the initial stage when acquiring the respective moving image content items, it is appropriate to select the lowest value as an initial content rate in many cases.

The content information lists as shown in FIG. 11A are used for the processes in steps S101 to S104. The client terminal 100 uses the content information lists as shown in FIG. 11A also for the subsequent processes.

After deciding the content rate at the initial stage when acquiring the respective moving image content items, the client terminal 100 creates an initial content acquiring list designated for each content item (step S105). The control unit 101 can create the content acquiring list, for example.

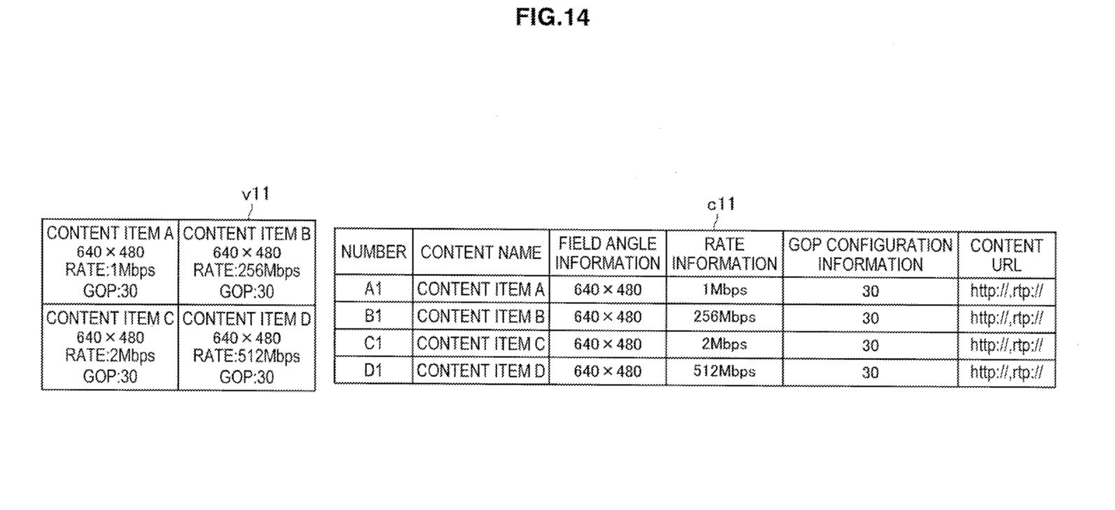

FIG. 14 shows an example of a content acquiring list c11. For example, it is assumed that GOP configurations and content rates of the respective content items are decided as shown in a screen v11 in FIG. 14 through the processes in steps S101 to S104. Based on this determination, the client terminal 100 creates the content acquiring list c11 shown in FIG. 14 from the content information lists shown in FIG. 11A.

After creating the initial content acquiring list c11 designated for each content item, the client terminal 100 requests to acquire the moving image content items from the moving image content servers 2 and 3 based on this content acquiring list c11 (step S106).

After the request is made to acquire the moving image content items from the moving image content servers 2 and 3 based on the content acquiring list, encoded streams of the moving image content items based on this request are distributed from the moving image content servers 2 and 3. The client terminal 100 receives the encoded streams distributed from the moving image content servers 2 and 3 and stores the received encoded streams in the content buffering units 104a, 104b, 104c, . . . , 104n. Then, the client terminal 100 determines whether or not it is decoding timing (step S107). When it is the decoding timing, the client terminal 100 extracts picture data from the content buffering units 104a, 104b, 104c, . . . , 104n (step S108), and after composite, executes decoding (step S109).

After starting acquiring the moving image content items from the moving image content servers 2 and 3, the client terminal 100 measures flow-in rates of the encoded streams to the content buffering units 104a, 104b, 104c, . . . , 104n (step S110). Further, the client terminal 100 calculates packet loss rates of data flowing into the content buffering units 104a, 104b, 104c, . . . , 104n (step S111). The transfer state determining unit 108 measures the flow-in rates and calculates the packet loss rates.

After measuring the flow-in rates of the encoded streams to the content buffering units 104a, 104b, 104c, . . . , 104n and calculating the packet loss rates of data flowing into the content buffering units 104a, 104b, 104c, . . . , 104n, the client terminal 100 determines whether or not a specific packet loss rate of any of the content buffering units 104a, 104b, 104c, . . . , 104n is higher than or equal to the threshold value set in step S103 for a certain period of time (step S112). The transfer state determining unit 108 can execute this determination.

As a result of the determination in step S112, when the packet loss rate is higher than or equal to the threshold value for a certain period of time, the client terminal 100 executes a GOP changing process (step S113). In step S113, the client terminal 100 executes a GOP changing process in which the current GOP configuration is made shorter.

After executing the GOP changing process in step S113, the client terminal 100 resets the packet loss rates of the content buffering units 104a, 104b, 104c, . . . , 104n, which are targets of the process (step S114).

Meanwhile, as a result of the determination in step S112, when the packet loss rate is not higher than or equal to the threshold value for a certain period of time, the client terminal 100 determines whether or not a specific packet loss rate of any of the content buffering units 104a, 104b, 104c, . . . , 104n is lower than the threshold value set in step S103 for a certain period of time (step S115). The transfer state determining unit 108 can execute this determination.

As a result of the determination in step S115, when the packet loss rate is lower than the threshold value for a certain period of time, the client terminal 100 executes a GOP changing process (step S116). In step S116, the client terminal 100 executes a GOP changing process in which the current GOP configuration is made longer.

After executing the GOP changing process in step S116, the client terminal 100 resets the packet loss rates of the content buffering units 104a, 104b, 104c, . . . , 104n, which are targets of the process (step S117).

Meanwhile, as a result of the determination in step S115, when the packet loss rate is not lower than the threshold value for a certain period of time, the client terminal 100 determines whether or not any of the content buffering units 104a, 104b, 104c, . . . , 104n has a flow-in rate that is lower than rate information of the content acquiring list for a certain period of time (step S118). The transfer state determining unit 108 can execute this determination.

As a result of the determination in step S118, when a content buffering unit has a flow-in rate that is lower than rate information of the content acquiring list for a certain period of time, the client terminal 100 executes a rate changing process (step S119). The fact that the flow-in rate is lower than rate information of the content acquiring list means that the client terminal 100 is receiving the encoded streams only at a rate that is lower than the rate designated by the moving image content servers 2 and 3. Accordingly, in step S119, the client terminal 100 executes the rate changing process in which the current rate is made lower (down).

After executing the rate changing process in step S119, the client terminal 100 resets the flow-in rates to the content buffering units 104a, 104b, 104c, . . . , 104n, which are targets of the process (step S120).

Meanwhile, as a result of the determination in step S118, when no content buffering unit has a flow-in rate that is lower than rate information of the content acquiring list for a certain period of time, the client terminal 100 determines whether or not any of the content buffering units 104a, 104b, 104c, . . . , 104n has a flow-in rate that is higher than or equal to rate information of the content acquiring list for a certain period of time (step S121). The transfer state determining unit 108 can execute this determination.

As a result of the determination in step S121, when a content buffering unit has a flow-in rate that is higher than or equal to rate information of the content acquiring list for a certain period of time, the client terminal 100 executes a rate changing process (step S122). The fact that the flow-in rate is higher than or equal to rate information of the content acquiring list means that the client terminal 100 is receiving the encoded streams at a rate higher than the rate designated by the moving image content servers 2 and 3. Accordingly, in step S122, the client terminal 100 executes the rate changing process in which the current rate is made higher (up).

After executing the rate changing process in step S122, the client terminal 100 resets the flow-in rates to the content buffering units 104a, 104b, 104c, . . . , 104n, which are targets of the process (step S123).

Meanwhile, as a result of the determination in step S121, when no content buffering unit has a flow-in rate that is higher than or equal to rate information of the content acquiring list for a certain period of time, the client terminal 100 determines whether or not there is a request to have a priority on the speed of switching content items as a user's request or a request from the application executed by the application unit 107 (step S124). The control unit 101 can execute this determination.

As a result of the determination in step S124, when there is a request to have a priority on the speed of switching content items, the client terminal 100 executes a GOP changing process (step S125). In step S125, the client terminal 100 executes the GOP changing process in which the current GOP configuration is made shorter.

Meanwhile, as a result of the determination in step S124, when there is no request to have a priority on the speed of switching content items, the client terminal 100 determines whether or not there is a request to have a priority on immediate restoration from an error as a user's request or a request from the application executed by the application unit 107 (step S126). The control unit 101 can execute this determination.

As a result of the determination in step S126, when there is a request to have a priority on immediate restoration from an error, the client terminal 100 executes a GOP changing process (step S127). In step S127, the client terminal 100 executes the GOP changing process in which the current GOP configuration is made shorter.

Meanwhile, as a result of the determination in step S126, when there is no request to have a priority on immediate restoration from an error, the client terminal 100 determines whether or not there is a request to increase the rate of a moving image content item as a user's request or a request from the application executed by the application unit 107 (step S128). The control unit 101 can execute this determination.

As a result of the determination in step S128, when there is a request to increase the rate of a moving image content item, the client terminal 100 executes a rate changing process (step S129). In step S129, the client terminal 100 executes the rate changing process in which the current rate is made higher (up).

Meanwhile, as a result of the determination in step S128, when there is no request to increase the rate of a moving image content item, the client terminal 100 determines whether or not there is a request to decrease the rate of a moving image content item as a user's request or a request from the application executed by the application unit 107 (step S130). The control unit 101 can execute this determination.

As a result of the determination in step S130, when there is a request to decrease the rate of a moving image content item, the client terminal 100 executes a rate changing process (step S131). In step S131, the client terminal 100 executes the rate changing process in which the current rate is made lower (down).

In order to acquire the subsequence of the moving image content items, the client terminal 100 updates the content acquiring list in accordance with the change in the GOP configuration or the rate (step S132). The control unit 101 can update the content acquiring list. After updating the content acquiring list, the client terminal 100 repeats a series of processes from the process in step S106.

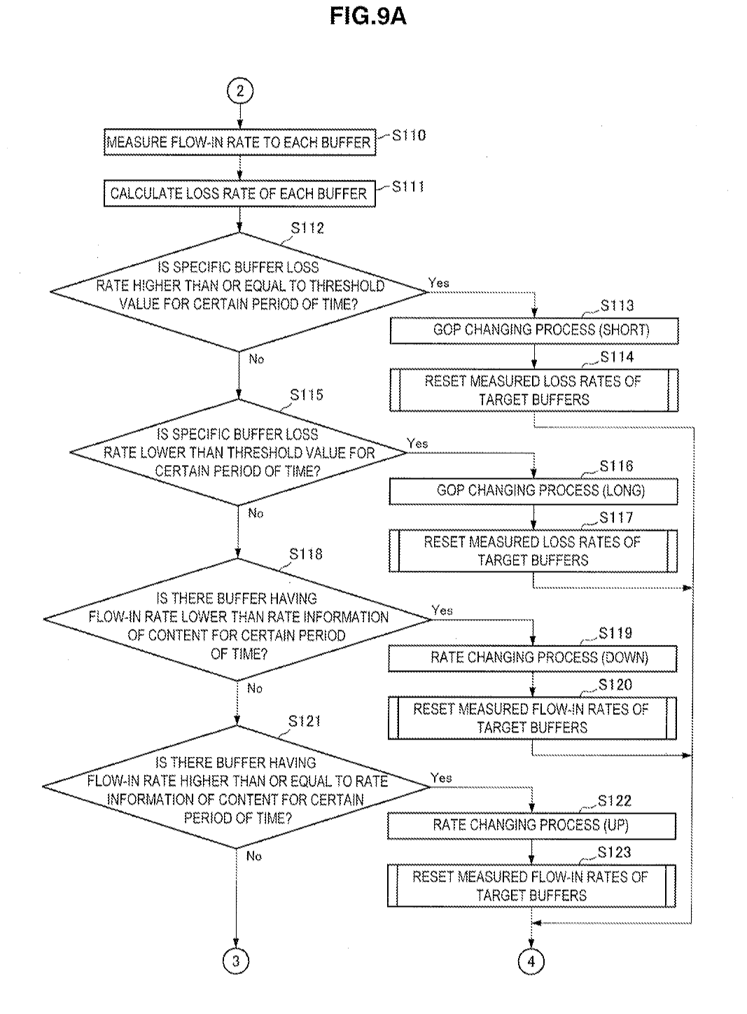

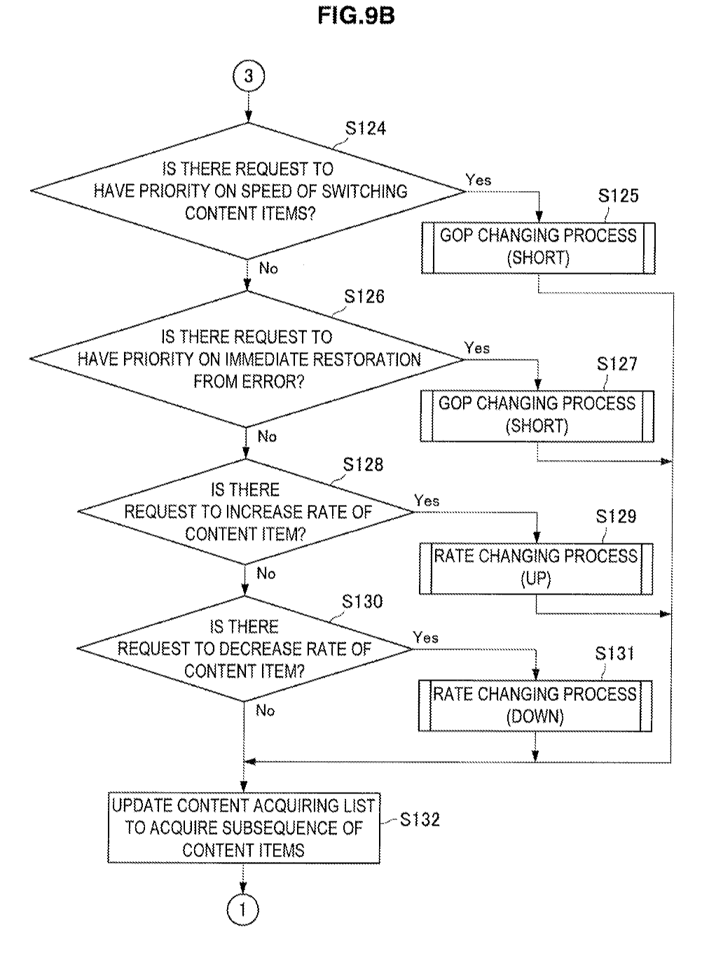

The processes shown in FIGS. 8 to 9B continue until the client terminal 100 completes simultaneous reproduction of a plurality of moving image content items.

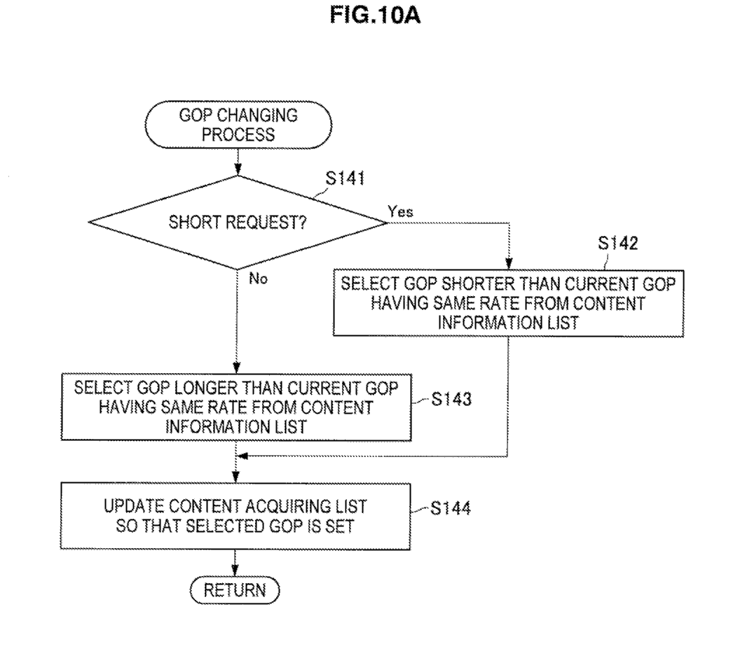

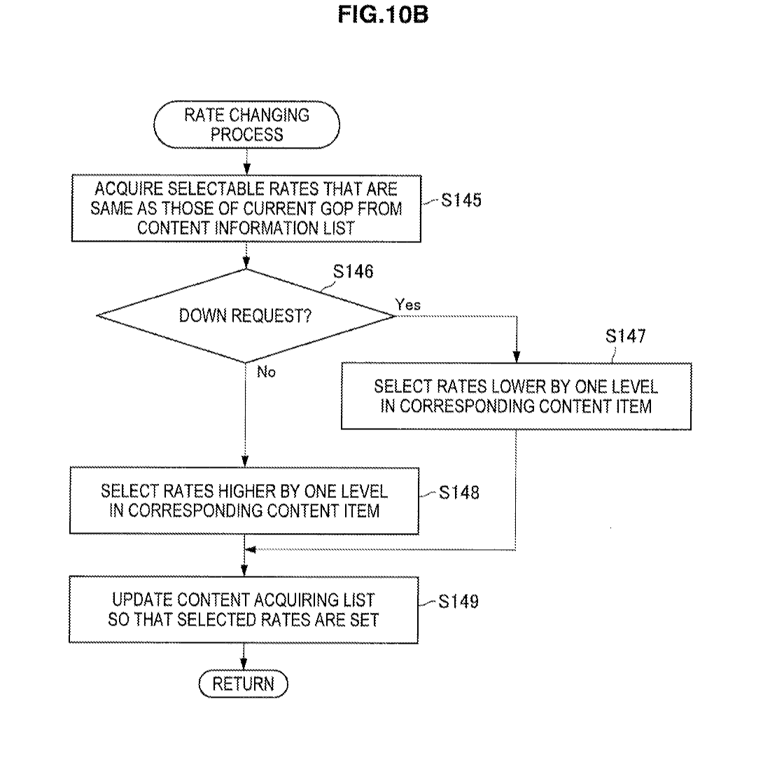

Next, the GOP configuration changing process executed by the client terminal 100 will be described in detail. FIG. 10A shows an operation example of the client terminal 100 according to an embodiment of the present disclosure. FIG. 10A shows an example of the GOP configuration changing process executed by the client terminal 100.

When changing a GOP configuration, the client terminal 100 first determines whether or not a request to make the current GOP configuration shorter (this request is referred to as “SHORT REQUEST” in FIG. 10A) is made (step S141). The control unit 101 can execute this determination.

As a result of the determination in step S141, when the request to make the current GOP configuration shorter (“SHORT REQUEST”) is made, the client terminal 100 selects a GOP configuration that is shorter than the current GOP configuration and has the same rate from the content information list (step S142). The GOP configuration information deciding unit 109 can execute this selection.

Meanwhile, as a result of the determination in step S141, when no request to make the current GOP configuration shorter (no “SHORT REQUEST”) is made, that is, a request to make the current GOP configuration longer (this request is referred to as “LONG REQUEST”) is made, the client terminal 100 selects a GOP configuration that is longer than the current GOP configuration and has the same rate from the content information list (step S143). The GOP configuration information deciding unit 109 can execute this selection.

After selecting the GOP configuration in accordance with the request in step S142 or S143, the client terminal 100 updates the content acquiring list so that the selected GOP configuration is set (step S144).

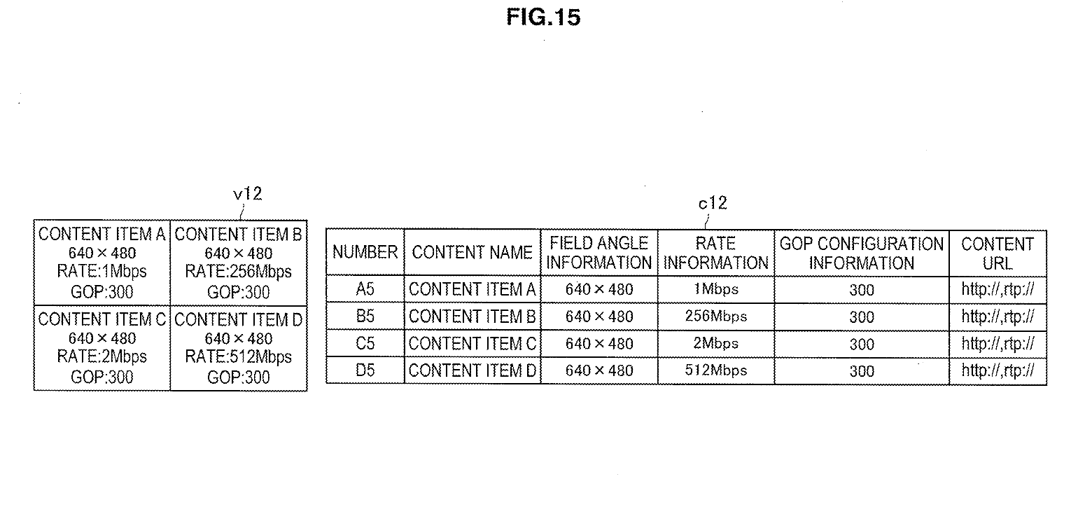

A specific example of the GOP configuration changing process will be described. FIG. 15 shows an example of a content acquiring list c12 in which the GOP configurations are made longer than those in the content acquiring list c11 shown in FIG. 14.

When the content information list is the content acquiring list c11 shown in FIG. 14 and the request to make the current GOP configurations longer (“LONG REQUEST”) is made, the client terminal 100 decides the GOP configurations of the respective moving image content items such that the GOP configurations that are longer than the current GOP configurations and have the same rate are set. In this case, by changing the GOP configurations from 30 to 300, it is possible to make the GOP configurations longer without changing the rates. Accordingly, the client terminal 100 updates the subjects in the content acquiring list such that the subjects are changed from those in the content acquiring list c11 to those in the content acquiring list c12.

In accordance with the change of the content information list into the content acquiring list c12, the client terminal 100 requests the moving image content items of the moving image content servers 2 and 3 based on the content acquiring list c12. As a result, the client terminal 100 simultaneously reproduces combined four moving image content items having the GOP configurations and content rates as shown in a screen v12 in FIG. 15.

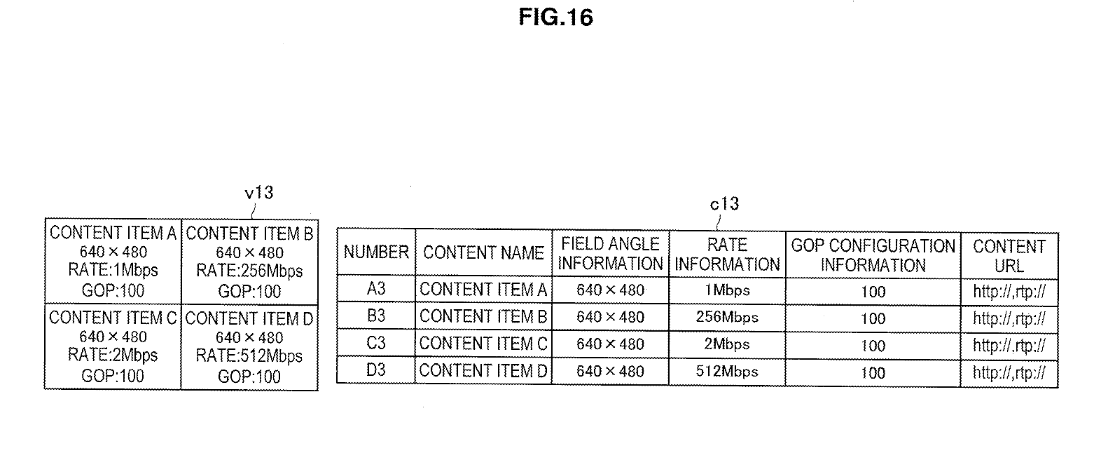

FIG. 16 shows an example of a content acquiring list c13 in which the GOP configurations are made shorter than those in the content acquiring list c12 shown in FIG. 15.

When the content information list is the content acquiring list c12 shown in FIG. 15 and the request to make the current GOP configurations shorter (“SHORT REQUEST”) is made, the client terminal 100 decides the GOP configurations of the respective moving image content items such that the GOP configurations that are shorter than the current GOP configurations and have the same rate are set. In this case, by changing the GOP configurations from 300 to 100, it is possible to make the GOP configurations shorter without changing the rates. Accordingly, the client terminal 100 updates the subjects such that the subjects are changed from those in the content acquiring list c12 to those in the content acquiring list c13.

In accordance with the change of the content information list into the content acquiring list c13, the client terminal 100 requests the moving image content items of the moving image content servers 2 and 3 based on the content acquiring list c13. As a result, the client terminal 100 simultaneously reproduces combined four moving image content items having the GOP configurations and content rates as shown in a screen v13 in FIG. 16.

Next, the rate changing process executed by the client terminal 100 will be described in detail. FIG. 10B shows an operation example of the client terminal 100 according to an embodiment of the present disclosure. FIG. 10B shows an example of the rate changing process executed by the client terminal 100.

When changing rates, the client terminal 100 first acquires selectable rates that are the same as those of the current GOP configurations from the content information list (step S145). After acquiring the selectable rates in step S145, the client terminal 100 determines whether or not a request to make the current rates lower (this request is referred to as “DOWN REQUEST” in FIG. 10B) is made (step S146). The control unit 101 can execute this determination.

As a result of the determination in step S146, when the request to make the current rates lower (“DOWN REQUEST”) is made, the client terminal 100 selects rates that are lower than the current rates by one level in the corresponding content item from the content information list (step S147). The rate information deciding unit 110 can execute this selection.

Meanwhile, as a result of the determination in step S146, no request to make the current rates lower (no “DOWN REQUEST”) is made, that is, a request to make the current rates higher (this request is referred to as “UP REQUEST”) is made, the client terminal 100 selects rates that are higher than the current rates by one level in the corresponding content item from the content information list (step S148). The rate information deciding unit 110 can execute this selection.

After selecting the rates in accordance with the request in step S147 or S148, the client terminal 100 updates the content acquiring list so that the selected rates are set (step S149).

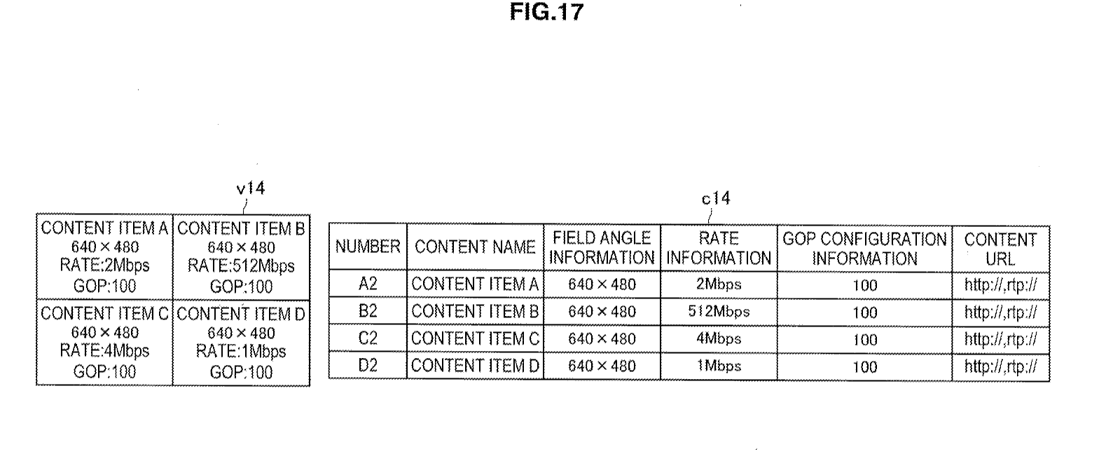

A specific example of the rate changing process will be described. FIG. 17 shows an example of a content acquiring list c14 in which the rates are made higher than those in the content acquiring list c13 shown in FIG. 16.

When the content information list is the content acquiring list c13 shown in FIG. 16 and the request to make the current rates higher (“UP REQUEST”) is made, the client terminal 100 decides the rates of the respective moving image content items such that the rates that are high than the current rates and have the same GOP configurations are set. In this case, by selecting the rates of the respective moving image content items shown in FIG. 17, the client terminal 100 can increase the rates without changing the GOP configurations. Accordingly, the client terminal 100 updates the subjects such that the subjects are changed from those in the content acquiring list c13 to those in the content acquiring list c14.

In accordance with the change of the content information list into the content acquiring list c14, the client terminal 100 requests the moving image content items of the moving image content servers 2 and 3 based on the content acquiring list c14. As a result, the client terminal 100 simultaneously reproduces combined four moving image content items having the GOP configurations and content rates as shown in a screen v14 in FIG. 17.

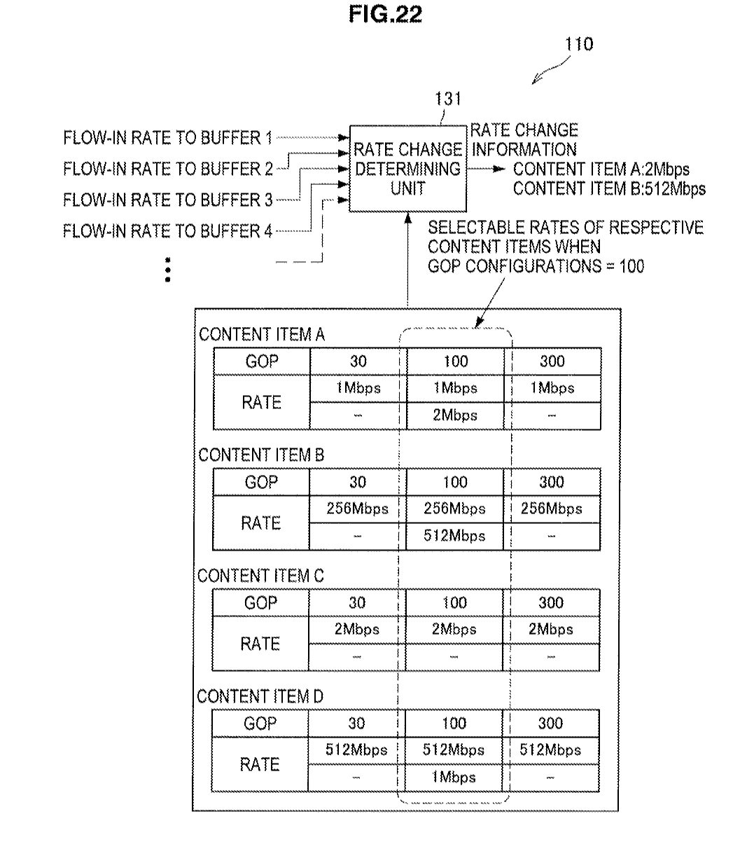

Here, a configuration example of the rate information deciding unit 110 will be described. FIG. 22 shows the configuration example of the rate information deciding unit 110. FIG. 22 shows the configuration example of the rate information deciding unit 110 for deciding rates based on flow-in rates to the content buffering units 104a, 104b, 104c, . . . , 104n, measured by the transfer state determining unit 108. As shown in FIG. 22, the rate information deciding unit 110 includes a rate change determining unit 131.

The rate change determining unit 131 receives the respective flow-in rates to the content buffering units 104a, 104b, 104c, . . . , 104n, measured by the transfer state determining unit 108, and determines whether or not the rates of the respective moving image content items are to be changed. For example, depending on the respective flow-in rates to the content buffering units 104a, 104b, 104c, 104n, the rates can be increased without problem in some cases. In those cases, the rate change determining unit 131 decides the rates of the respective moving image content items such that the GOP configurations are the same and the rates are made higher than the current rates.

In the example shown in FIG. 22, it is assumed that the current GOP configurations are 100, the current rate of the moving image content item A is 1 Mbps and the current content rate of the moving image content item B is 256 kbps. In this case, when it is determined that an increase in the rates of the moving image content items A and B causes no problems, the rate change determining units 131 can select, from the content information list, rates that are higher than the current rates by one level for the moving image content items A and B having the GOP configurations of 100. In the example shown in FIG. 22, the rate change determining unit 131 can select 2 Mbps as the rate of the moving image content item A and 512 kbps as the rate of the moving image content item B.

The rate change determining unit 131 can change the rates of only one or more of the moving image content items, instead of all the moving image content items, which are being received, while keeping the GOP configurations. For example, when there is no room in the band of the network 10, the rate change determining unit 131 may change the rates of only one or more of the moving image content items while keeping the GOP configurations such that the increase in the rates becomes small. Meanwhile, when there is room in the band of the network 10, the rate change determining unit 131 may change the rates of all the moving image content items being received while keeping the GOP configurations. Alternatively, the rate change determining unit 131 may change the rates of only one or more of the moving image content items while keeping the GOP configurations such that the increase in the rates becomes as large as possible within a range having room.

The client terminal 100 according to an embodiment of the present disclosure executes the above-described operations, so that it becomes possible to change GOP configurations while keeping the same GOP configurations in all content items when performing multi-screen composite using encoded stream information. Further, the client terminal 100 according to an embodiment of the present disclosure executes the above-described operations, so that it becomes possible to change content rates while keeping the same GOP configurations in all content items.

### 2. CONCLUSION

As described above, according to an embodiment of the present disclosure, it is possible to provide the client terminal 100 that combines a plurality of encoded streams and decodes the combined encoded streams, thereby simultaneously reproducing a plurality of moving image content items. Further, the client terminal 100 according to an embodiment of the present disclosure can change GOP configurations or rates while keeping the same GOP configurations in all content items in accordance with a user's instruction or a receiving state of the encoded streams when combining the plurality of encoded streams.

By shortening the GOP configurations while keeping the same GOP configurations in all content items, the client terminal 100 according to an embodiment of the present disclosure can shorten time to switch the moving image content items. Further, by shortening the GOP configurations while keeping the same GOP configurations in all content items, the client terminal 100 according to an embodiment of the present disclosure can shorten time to be restored from a packet loss. Further, by lengthening the GOP configurations while keeping the same GOP configurations in all content items, the client terminal 100 according to an embodiment of the present disclosure can increase encoding efficiency and display beautiful moving image content items.

Steps in processes executed by devices in this specification are not necessarily executed chronologically in the order described in a sequence chart or a flow chart. For example, steps in processes executed by devices may be executed in a different order from the order described in a flow chart or may be executed in parallel.

Further, a computer program can be created which causes hardware such as a CPU, ROM, or RAM, incorporated in each of the devices, to function in a manner similar to that of structures in the above-described devices. Furthermore, it is possible to provide a recording medium having the computer program recorded thereon. Moreover, by configuring respective functional blocks shown in a functional block diagram as hardware, the hardware can achieve a series of processes.

Although preferred embodiments of the present disclosure are described in detail with reference to the accompanying drawings, the technical scope of the present disclosure is not limited thereto. It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing device including:

a combining unit configured to acquire, for each of a plurality of content items, any of a plurality of streams in which a same content item is encoded by different picture configurations and to combine the acquired streams before the streams are decoded; and

a stream selecting unit configured to acquire information on the picture configurations of each of the streams and to select, using the acquired information on the picture configurations, a stream for each of the content items from among the plurality of streams in a manner that the picture configurations of each of the streams combined by the combining unit are same.

(2) The image processing device according to (1), wherein the stream selecting unit selects the stream in accordance with a state of a network through which each of the streams is transmitted.

(3) The image processing device according to (1) or (2), further including:

a situation detecting unit configured to detect a change in a situation of the network,

wherein the stream selecting unit decides a suitable configuration of a picture set in accordance with the change detected by the situation detecting unit.

(4) The image processing device according to (3),

wherein the situation detecting unit calculates information related to a packet loss of the streams distributed through the network, and

wherein the stream selecting unit decides the suitable configuration of the picture set using the information calculated by the situation detecting unit.

(5) The image processing device according to (3) or (4), further including:

a rate deciding unit configured to decide an acquiring rate of the streams in accordance with a result of detection performed by the situation detecting unit,

wherein the rate deciding unit decides the acquiring rate in a manner that the picture configurations of the streams that are reproduced simultaneously are same.

(6) The image processing device according to any one of (1) to (5), wherein the stream selecting unit acquires the information on the picture configurations from individual devices that transmit the content items.

(7) The image processing device according to (6), wherein, when one of the content items has information on a picture configuration that the other content items do not have, the stream selecting unit removes the information on the picture configuration from the acquired information on the picture configurations.

(8) The image processing device according to (6) or (7), wherein the stream selecting unit acquires information on a range of picture configurations that the individual devices can provide as the information on the picture configurations from the individual devices that transmit the content items.

(9) An image processing method including:

acquiring, for each of a plurality of content items, any of a plurality of streams in which a same content item is encoded under different conditions and combining the acquired streams before the streams are decoded; and

acquiring information on picture configurations of each of the streams and selecting, using the acquired information on the picture configurations, a stream for each of the content items from among the plurality of streams in a manner that the picture configurations of each of the streams combined in the combining step are same.

(10) A computer program causing a computer to execute:

acquiring, for each of a plurality of content items, any of a plurality of streams in which a same content item is encoded under different conditions and combining the acquired streams before the streams are decoded; and

acquiring information on picture configurations of each of the streams and selecting, using the acquired information on the picture configurations, a stream for each of the content items from among the plurality of streams in a manner that the picture configurations of each of the streams combined in the combining step are same.

What is claimed is:

1. An image processing device comprising:
a combining unit configured to acquire, for each of a plurality of content items, any of a plurality of streams in which a same content item is encoded by different picture configurations and to combine the acquired streams before the streams are decoded; and
a stream selecting unit configured to acquire information on the picture configurations of each of the streams and to select, using the acquired information on the picture configurations, a stream for each of the content items from among the plurality of streams in a manner that the picture configurations of each of the streams combined by the combining unit are same.

2. The image processing device according to claim 1, wherein the stream selecting unit selects the stream in accordance with a state of a network through which each of the streams is transmitted.

3. The image processing device according to claim 2, further comprising:
a situation detecting unit configured to detect a change in a situation of the network,
wherein the stream selecting unit decides a suitable configuration of a picture set in accordance with the change detected by the situation detecting unit.

4. The image processing device according to claim 3,
wherein the situation detecting unit calculates information related to a packet loss of the streams distributed through the network, and
wherein the stream selecting unit decides the suitable configuration of the picture set using the information calculated by the situation detecting unit.

5. The image processing device according to claim 3, further comprising:
a rate deciding unit configured to decide an acquiring rate of the streams in accordance with a result of detection performed by the situation detecting unit,
wherein the rate deciding unit decides the acquiring rate in a manner that the picture configurations of the streams that are reproduced simultaneously are same.

6. The image processing device according to claim 1, wherein the stream selecting unit acquires the information on the picture configurations from individual devices that transmit the content items.

7. The image processing device according to claim 6, wherein, when one of the content items has information on a picture configuration that the other content items do not have, the stream selecting unit removes the information on the picture configuration from the acquired information on the picture configurations.

8. The image processing device according to claim 6, wherein the stream selecting unit acquires information on a range of picture configurations that the individual devices can provide as the information on the picture configurations from the individual devices that transmit the content items.

9. An image processing method comprising:
acquiring, for each of a plurality of content items, any of a plurality of streams in which a same content item is encoded under different conditions and combining the acquired streams before the streams are decoded; and
acquiring information on picture configurations of each of the streams and selecting, using the acquired information on the picture configurations, a stream for each of the content items from among the plurality of streams in a manner that the picture configurations of each of the streams combined in the combining step are same.

10. A computer program causing a computer to execute:
acquiring, for each of a plurality of content items, any of a plurality of streams in which a same content item is encoded under different conditions and combining the acquired streams before the streams are decoded; and
acquiring information on picture configurations of each of the streams and selecting, using the acquired information on the picture configurations, a stream for each of the content items from among the plurality of streams in a manner that the picture configurations of each of the streams combined in the combining step are same.
